(19) United States
(12) Patent Application Publication
(10) Pub. No.: US 2009/0066598 A1
(43) Pub. Date: Mar. 12, 2009

(54) Modular waveguide feed horn

(75) Inventors: Charles Randall Malstrom, Lebanon, PA (US); Michael Frederick Laub, Harrisburg, PA (US); Michael Robert Lau, San Ramon, CA (US); Samuel Hiburn Ahrendes, San Jose, CA (US); Eric Franklin Richardson, San Jose, CA (US); John W. McGuire, Groton, MA (US)

Correspondence Address: Brian C. Oakes;Tyco Electronics Corporation, Suite 140, 4550 New Linden Hill Road, Wilmington, DE, 19808-2952, US

(73) Assignee: Tyco Electronics Corporation and M/A-Com, Inc.

(21) Appl. No.: 11/900,127

(22) Filed: Sep. 7, 2007

(51) Int. Cl. H01Q 13/02

(52) U.S. Cl. 343/786

(57) ABSTRACT

A modular waveguide feed horn is provided that includes an assembly having a waveguide plate section. The modular waveguide feed horn assembly also includes a feed horn section having at least one feed horn. The feed horn section is separately provided from and removably coupled to the waveguide plate section.

### BACKGROUND OF THE INVENTION

This invention relates generally to feed horns, and more particularly, to methods for manufacturing a modular waveguide feed horn.

A waveguide is a structure that guides waves, such as electromagnetic waves, light or sound waves. For example, an acoustic waveguide generally includes a duct or other similar structure for sound propagation and that directs the waveguide. The acoustic waveguide typically includes a feed horn, which is a horn antenna that is used to convey radio waves between, for example, a transmitter or receiver and a reflector. As an example, in radio transmission, the feed horn operates as an open-ended waveguide that is generally of increasing cross-sectional area and that radiates directly in a desired direction or feeds a reflector that forms a desired beam. For example, feed horns may have one or more expansion curves, for example, longitudinal cross sections, such as elliptical, conical, hyperbolic or parabolic curves. Accordingly, different beam patterns may be formed by controlling the dimensions and shapes of the feed horns. Essentially, the feed horn defines a portion of the waveguide in which the cross-section is smoothly increased (e.g., linearly or exponentially increased) along the axial direction, thereby defining an increasing cross-sectional area.

Current waveguide feed horn assemblies are fabricated from a single piece of metal (e.g., aluminum). The fabrication involves extensive precision computer numerical control (CNC) machining and wire electrical discharge machining (EDM) processes. In particular, the CNC machining is performed on an entire piece of metal and the EDM process forms the internal waveguide features. This machining process results in a single assembly or unit forming the feed horns on a waveguide plate. This process is not only time consuming, but significantly increases the cost of the assembly due in part to the wasted metal that is machined away during the fabrication process.

### BRIEF DESCRIPTION OF THE INVENTION

In one embodiment, a waveguide feed horn assembly is provided that includes a waveguide plate section. The waveguide feed horn assembly also includes a feed horn section including at least one feed horn. The feed horn section is separately provided from and removably coupled to the waveguide plate section.

In another embodiment, a feed horn is provided. The feed horn includes an upper funneled portion and a lower engagement portion having a conductive gasket.

In yet another embodiment, a method for providing a waveguide feed horn assembly includes forming a waveguide plate. The method further includes forming at least one feed horn separate from the waveguide plate and that is configured to be removably coupled to the waveguide plate.

### BRIEF DESCRIPTION OF THE DRAWINGS

FIG. 1 is a top perspective view of a portion of a modular waveguide feed horn assembly constructed in accordance with various embodiments of the invention.

FIG. 2 is a bottom perspective view of a portion of a modular waveguide feed horn assembly constructed in accordance with various embodiments of the invention.

FIG. 3 is a perspective view of a modular waveguide feed horn assembly constructed in accordance with various embodiments of the invention.

FIG. 4 is a side perspective view of a portion of a modular waveguide feed horn assembly constructed in accordance with various embodiments of the invention illustrating feed horns both assembled to and separate from a waveguide plate.

FIG. 5 is a top perspective view of a pair of feed horns formed in accordance with an embodiment of the invention.

FIG. 6 is a top perspective view of a pair of feed horns formed in accordance with another embodiment of the invention.

FIG. 7 is a bottom perspective view of the pair of feed horns shown in FIG. 5.

FIG. 8 is another top perspective view of a pair of feed horns formed in accordance with an embodiment of the invention.

### DETAILED DESCRIPTION OF THE INVENTION

For simplicity and ease of explanation, the invention will be described herein in connection with various embodiments thereof. Those skilled in the art will recognize, however, that the features and advantages of the various embodiments may be implemented in a variety of configurations. It is to be understood, therefore, that the embodiments described herein are presented by way of illustration, not of limitation.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

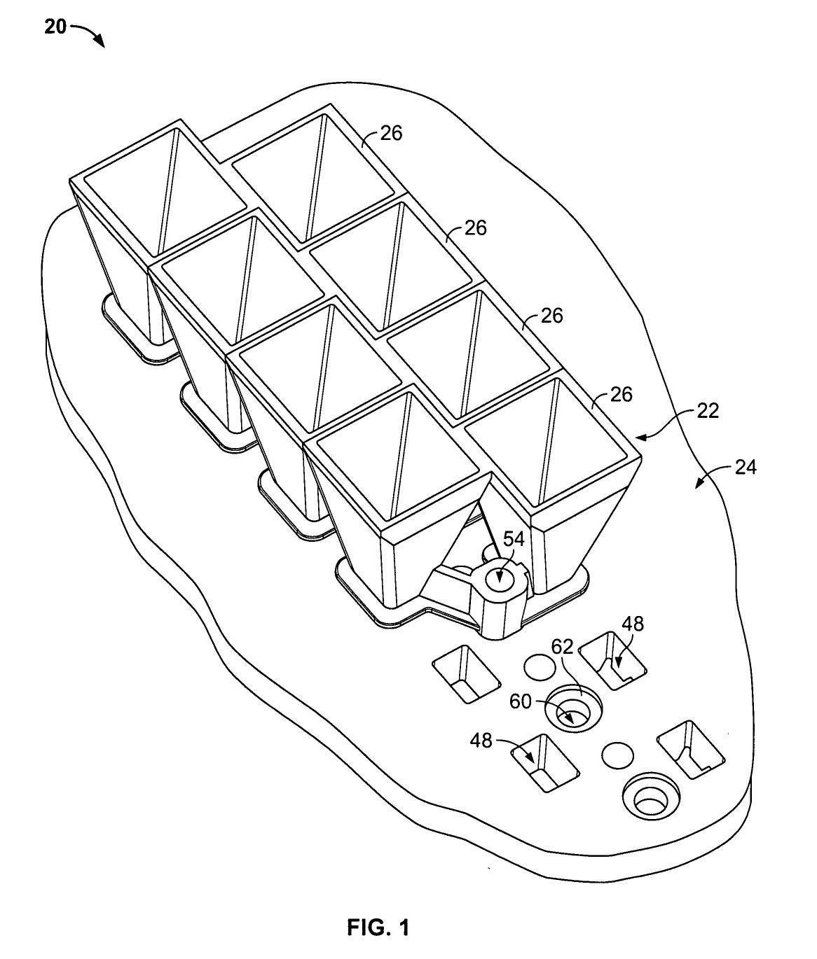

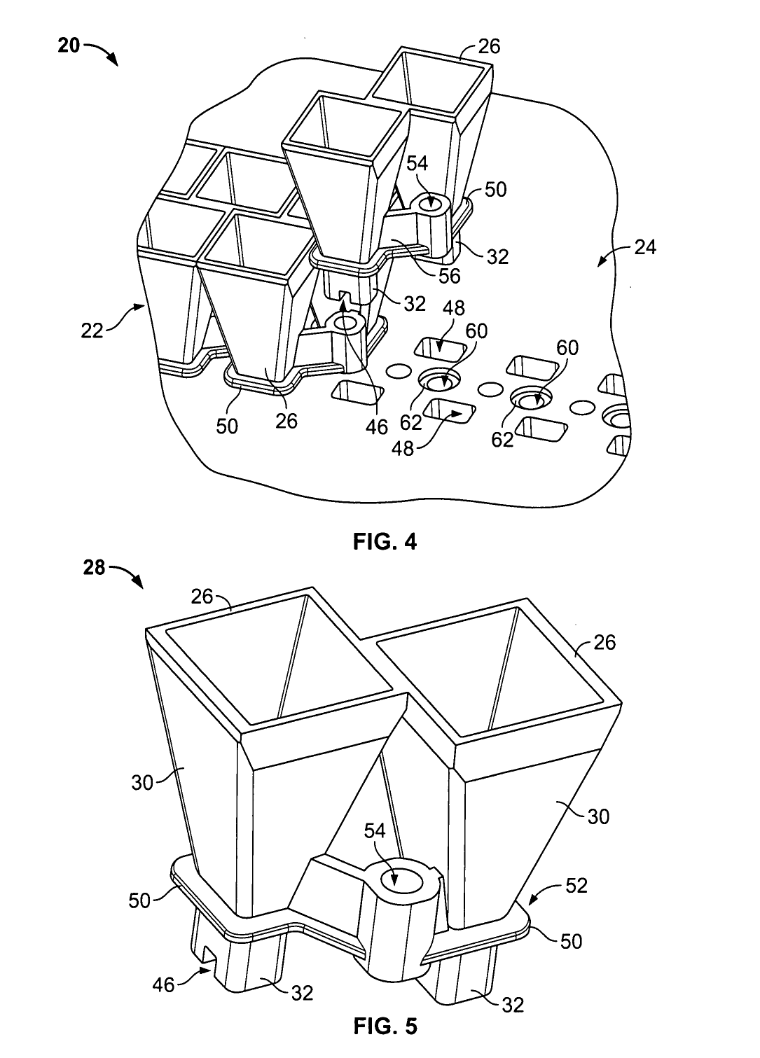

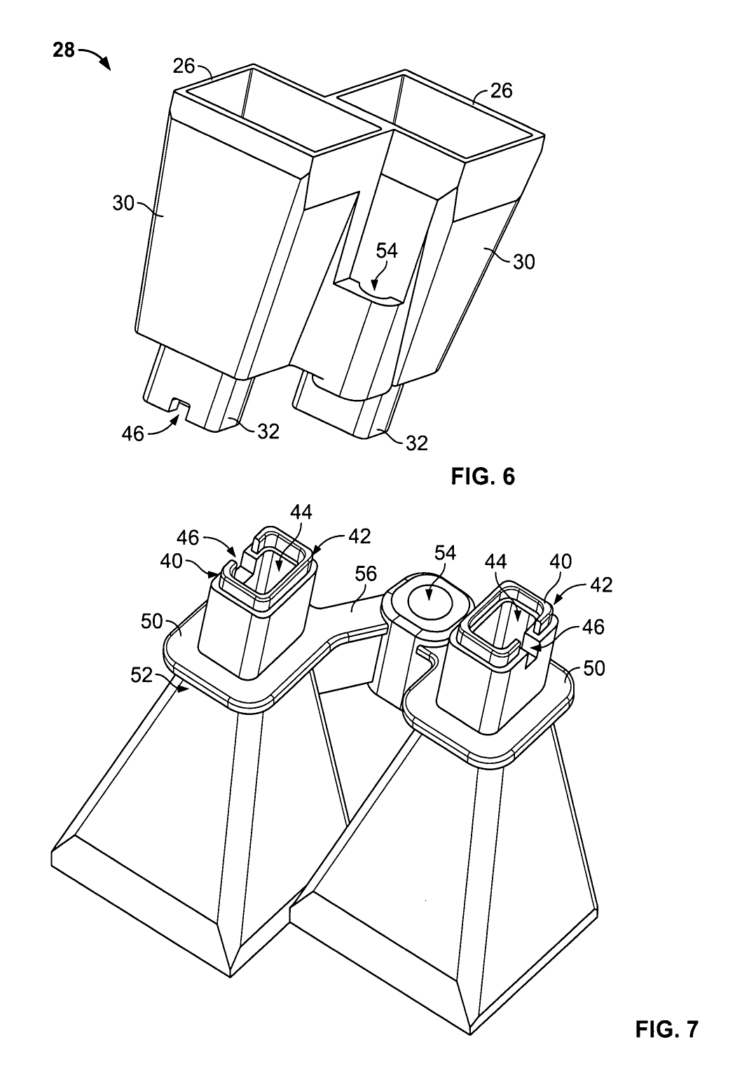

Various embodiments of the invention provide a modular molded waveguide feed horn assembly having a multiple piece design, for example, a two piece design. The modular molded waveguide feed horn assembly 20 (or a portion thereof) is shown generally in FIGS. 1 through 4. The modular molded waveguide feed horn assembly 20 will hereafter be referred to as the waveguide feed horn assembly 20. The waveguide feed horn assembly 20 generally includes a feed horn section 22 and a waveguide plate section 24. The feed horn section 22 includes a plurality of feed horns 26, which in various embodiments, comprise a plurality of multiple molded horn modules assembled to form an array of feed horns 26. For example, the feed horns 26 may be formed (e.g., molded) in pairs to define molded horn modules. However, other configurations are contemplated. For example, the feed horns 26 may be formed individually or in groups of larger numbers, for example, in groups of two, three, four, five, six, etc. to define feed horn modules 28, for example, as shown in FIGS. 5 and 6 (illustrated as pairs of feed horns 26). Thus, multiple feed horn modules 28 may be assembled to the waveguide plate section 24 (as described in more detail below) to form larger feed horn arrays (e.g., arrays of sixteen feed horns, twenty feed horns 26, twenty-four feed horns, thirty feed horns, thirty-two feed horns, forty feed horns, etc.).

Referring to FIGS. 5 and 6, each of the feed horns 26 generally includes an upper funneled portion 30 and a lower engagement portion 32. The feed horns 26 may be formed from different types of materials. For example, the feed horns 26 may be formed from plastic (or other synthetic material) as shown in FIG. 5 or formed from metal as shown in FIG. 6. However, the particular configuration of the feed horns 26 is not limited to or based on the type of material used. If formed using plastic (or other synthetic material), the feed horns 26 may be formed using, for example, a plastic injection molding process or a CNC machining process. If formed from a metal, the feed horns 26 may be formed using, for example, a metal injection molding (MIM) process or a cast molding process. Depending on the type of material used, a material specific process may be used. For example, if the feed horns 26 are formed from magnesium, then a magnesium injection molding process (e.g., Thixomolding process) may be used.

It should be noted that the feed horns 26, whether formed from plastic, metal or other material may be coated or plated. For example, the feed horns 26 may be metal plated using any suitable process to provide an electrical signal path to ground through the waveguide plate section 24 as described in more detail below. Any suitable conductive finish may be used, for example, gold, silver, copper nichrome (CuNiCr), nickel, chem.-film, etc. These materials may be applied through any known plating process, for example, electro-plating, plasma vapor deposition (PVD), etc. The feed horns 26 are essentially provided with a metallization of the functional surfaces of the feed horn 26 to provide electrical signal conductivity when assembled to the waveguide plate section 24. The waveguide plate section also may be assembled to a circuit board (not shown), for example, a printed circuit board. The feed horns 26 may be plated individually or as groups and may be entirely plated or partially plated. For example, each feed horn module 28 may be plated at one time. Also different types of plating materials may be used, for example, a different plating material inside and outside the feed horn 26. If the feed horns 26 are formed of a metal material, the metal plating also acts to resist oxidation and corrosion and may be plated using, for example, copper nichrome (CuNiCr) (which also may be used to plate plastic feed horns 26). Alternatively, the metal feed horns 26 (e.g., aluminum feed horns 26) may be plated with a chemical film coating, sometimes referred to as a Chem Film. For example, a chromate conversion coating may be applied to aluminum surfaces of the metal feed horns 26.

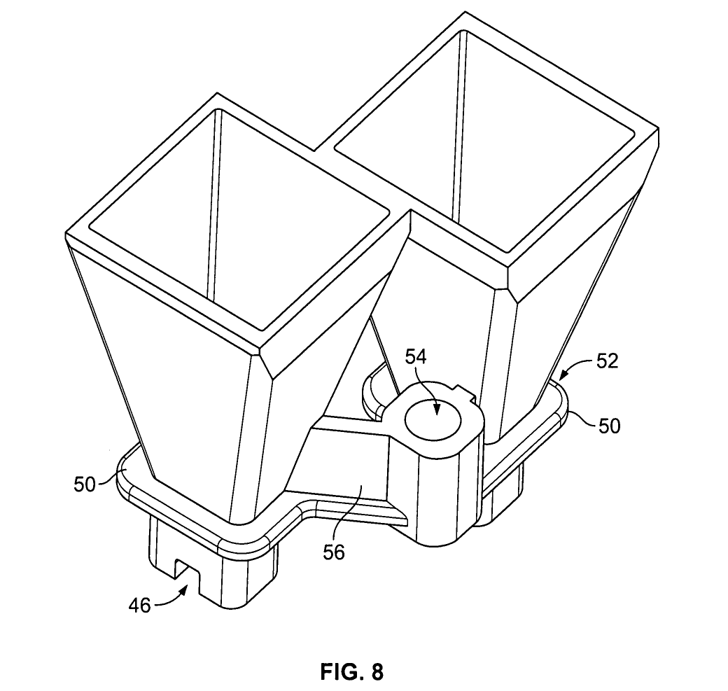

The feed horns 26 each also include a gasket 40 as shown in FIG. 7. In one embodiment, the gasket 40 is a conductive gasket that is provided on the lower engagement portion 32 of the feed horns 26 and may be a form-in-place type of gasket. For example, the gasket 40 may be machine dispensed in a liquid form and cured (form-in-place). However, other suitable processes may be used. Accordingly, the gasket 40 may be provided along a bottom edge 42 of an opening 44 of the lower engagement portion 32. The gasket 40 also does not have to be formed on the feed horn 26. For example, the gasket 40 may be provided on a circuit card assembly (CCA) to which the waveguide plate section 24 is connected. The gasket 40 also may be a separate component having, for example, a pressure sensitive adhesive (PSA) that is peeled and then gasket 40 adhered to the appropriate surface.

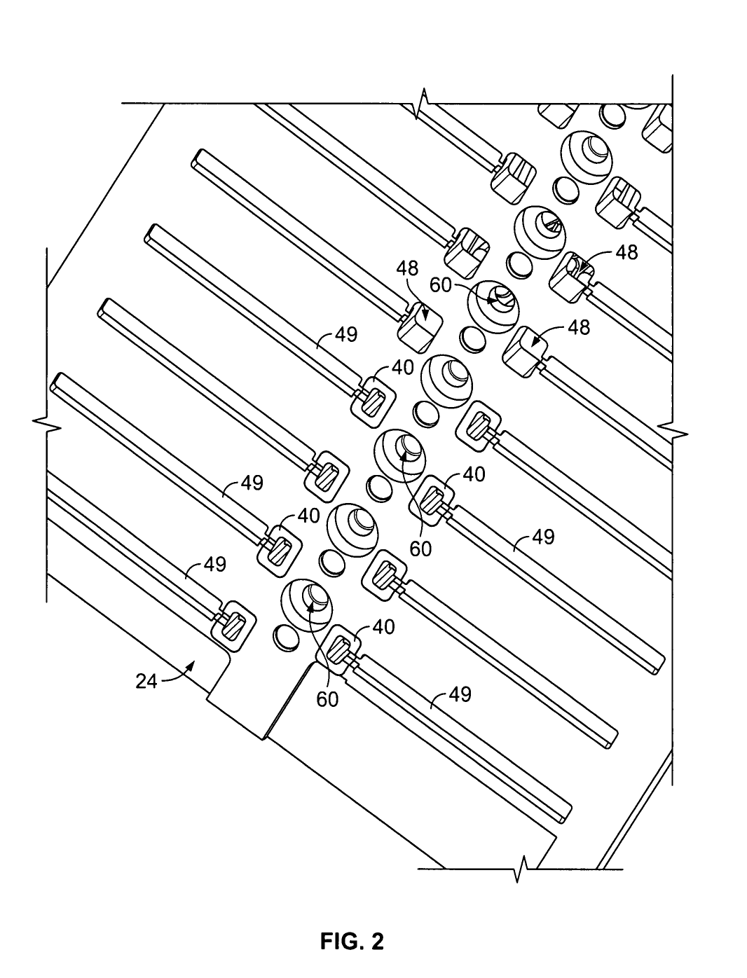

The gasket 40 may be formed from any material providing an electrical ground contact at the interface of the feed horn 26 and a bottom surface of the waveguide plate section 24 (shown in FIG. 2) that is to be connected, for example, to a CCA or circuit board assembly. The gasket 40 may be, for example, a conductive gasket that includes metal fillers (e.g., a tri-shield gasket available from TennMax America of Vancouver or a conductive elastomer seal available from Chomerics (a division of Parker-Hannifin Corp.) of Woburn, Mass.). The gasket 40 also may be, for example, a metal gasket that is compilable. The gasket 40 also may account for tolerances mismatches between the feed horn 26 and the waveguide plate section 24 when inserted therein as shown in FIG. 2. For example, the gasket 40 allows for some margin in the tolerance when forming the waveguide plate section 24 (e.g., machining the waveguide plate section 24). In general, the gasket 40 may be formed of any material that provides proper ground and that also can accommodate certain manufacturing tolerances. It should also be noted that the gasket 40 may be removed and other suitable grounding provided. The gasket 40 ensures that a signal entering the feed horn 26 travels, for example, on a trace of a CCA or that a signal originating from the CCA travels into the feed horn 26 (depending on whether transmitting or receiving operation is being performed).

The lower engagement portion 32 also includes a notch 46 as shown in FIGS. 5 through 8. The notch 46 may be provided on one side of the lower engagement portion 32 and/or on opposite sides of the lower engagement portions 32 of pairs of feed horns 26 (e.g., on opposite sides of pairs of feed horn modules 28). The notch 46 is configured having a shape and size that aligns with a channel 49 (shown in FIG. 2) on a bottom of the waveguide plate section 24 when inserted into the opening 48 (e.g., slip fit connection). The notch 46 in combination with the channel 49 are adapted to receive circuit traces therein, for example, circuit traces of a CCA to which the waveguide plate section 24 is connected. Thus, a path through which a signal can enter or leave the waveguide plate section 24 is provided. For example, an RF signal can travel along the trace and then is directed into the feed horns 26 by the gasket 40 and through the notch 26 having a portion of the trace therein.

The lower engagement portion 32 in one embodiment has a generally rectangular cross-section configured to engage within the opening 48 of the waveguide plate section 24. However, the lower engagement portion 32 may have different cross-section shapes, for example, oval, circular, triangular, etc. with the opening 48 have a corresponding shape. As shown in the embodiments of FIGS. 5, 7 and 8, the lower engagement portion 32 generally defines a box-shaped member with the gasket 40 at one end and a flange 50 at the other end. The flange 50 generally forms a rim or shelf at a base 52 of the feed horn 26. The flange 50 engages a top surface of the waveguide plate section 24 to resist movement of the lower engagement portion 32 through the opening 48 and ensure proper compression of the gasket 40. The flange 50 also can act as an electrical short to prevent or resist electrical current flow in the event a signal leaks through the interface between the waveguide plate section 24 and the feed horn 26.

A mounting opening 54 (e.g., bore) is also provided between groups (e.g., pairs) of feed horns 26. For example, the mounting opening 54 may be provided in an offset orientation relative to the feed horns 26 and formed in a connection member 56 (e.g., a connection arm) between the feed horns 26. A corresponding opening 60 (shown in FIGS. 1 through 4) is provided in the waveguide plate section 24 such that a fastener (not shown), for example, a bolt or screw extends through the mounting opening 54 and into the opening 60 to couple or engage (e.g., secure) the feed horns 26 to the waveguide plate section 24. Threading may be provided in the mounting opening 54, the corresponding opening 60, or both.

The feed horns 26 are mounted to the waveguide plate section 24 as shown in FIGS. 1 through 4. The engagement portions 32 of the feed horns 26 are inserted within the openings 48 of the waveguide plate section 24 with the notch 46 aligning with the channel 49. Groups of feed horns 26, for example, feed horn modules 28, such as pairs of feed horns 26 together form an array when mounted to the waveguide plate section 24. The feed horns 26 are coupled (e.g., connected or secured) to the waveguide plate section 24 using a fastener (not shown), such as a bolt or screw, that extends through the mounting opening 54 of the feed horns 26 and into the openings 60 of the waveguide plate section 24 (or vice versa). It should be noted that the openings 60 may be slightly larger than the structure forming the mounting openings 54 such that a portion of the structure engages within the opening 60 and abuts a shoulder 62 therein.

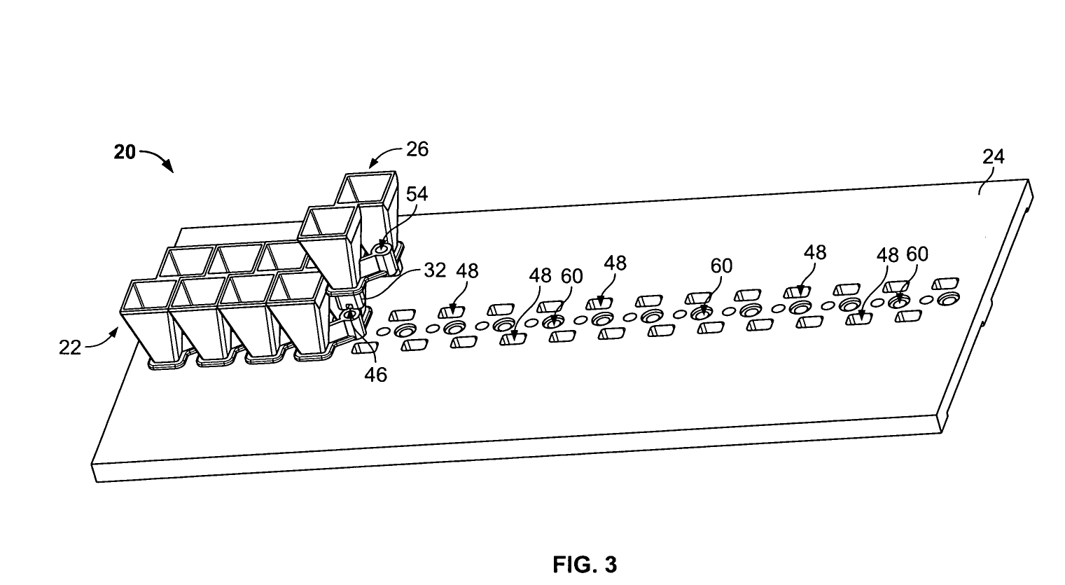

The feed horn modules 28 are configured such that when mounted to the waveguide plate section 24 (e.g., slip fit engagement), the feed horn modules 28 are aligned in abutting arrangement to form an array of feed horns 26 as shown in FIGS. 1 and 3. The feed horns 26, and more particularly, the gaskets 40 of the feed horns 26, when the feed horns 26 are mounted to the waveguide plate section 24 also form a generally planar surface at the bottom of the openings 48 of the waveguide plate section 24 as shown in FIG. 2.

Thereafter, the waveguide plate section 24 may be mounted to a device, system, component, etc. For example, the waveguide plate section 24 then may be connected to a printed circuit board used to control communication of signals through the feed horns 26.

Thus, various embodiments of the invention provide feed horns that are separate units from a waveguide plate and coupled thereto in different numbers. Accordingly, less material (e.g., metal) is wasted when machining the waveguide plate. The number of feed horns also may be increased or decreased as desired or needed. For example, when using the feed horns in an imaging device or application, such as an x-ray scanner or thermal imaging scanner, increasing the number of feed horns provides higher image resolution.

It should be noted that modifications and variations to the various embodiments are contemplated. For example, the shape and size of the feed horns may be modified based on the particular application, use, etc. For example, the geometry of the feed horns affects the transmission and reception properties. Thus, the internal design of the fed horns may be modified based on transmission frequency requirements.

Accordingly, it is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description.

The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A waveguide feed horn assembly comprising:
a waveguide plate section; and
a feed horn section including at least one feed horn, the feed horn section separately provided from and removably coupled to the waveguide plate section.

2. A waveguide feed horn assembly in accordance with claim 1 further comprising a plurality of feed horns that are formed in pairs.

3. A waveguide feed horn assembly in accordance with claim 1 wherein the at least one feed horn comprises an engagement portion configured to be inserted into an opening of the waveguide plate section.

4. A waveguide feed horn assembly in accordance with claim 1 wherein the at least one feed horn comprises an engagement portion having a notch configured to align with a channel of the waveguide plate section.

5. A waveguide feed horn assembly in accordance with claim 1 wherein the at least one feed horn comprises an engagement portion and wherein a gasket is provided on one of a lower end of the engagement portion and on a circuit card assembly to which the waveguide plate section is to be connected.

6. A waveguide feed horn assembly in accordance with claim 5 wherein the gasket comprises a tri-shielded gasket.

7. A waveguide feed horn assembly in accordance with claim 5 wherein the gasket comprises a conformable conductive material.

8. A waveguide feed horn assembly in accordance with claim 1 wherein the at least one feed horn comprises one of a plastic injection molded structure and a molded or machined metal structure.

9. A waveguide feed horn assembly in accordance with claim 8 wherein the at least one feed horn is plated with one of a metal and a conductive oxide.

10. A waveguide feed horn assembly in accordance with claim 1 wherein the feed horn section comprises at least one mounting opening configured to receive a fastener therein to couple the feed horn section to the waveguide plate section.

11. A waveguide feed horn assembly in accordance with claim 10 further comprising a plurality of feed horns and wherein the at least one mounting opening is provided in an offset arrangement between at least two of the plurality of feed horns.

12. A waveguide feed horn assembly in accordance with claim 1 wherein the at least one feed horn comprises a flange configured to abut a top surface of the waveguide plate section.

13. A waveguide feed horn assembly in accordance with claim 1 further comprising a plurality of feed horns configured in an abutting arrangement to form a feed horn array.

14. A feed horn comprising:
an upper funneled portion; and
a lower engagement portion having a conductive gasket.

15. A feed horn in accordance with claim 14 wherein the conductive gasket comprises a conformable material having metal fillers.

16. A feed horn in accordance with claim 14 wherein the lower engagement portion comprises a flange.

17. A feed horn in accordance with claim 14 wherein the upper funneled portion and lower engagement portion comprise a plastic material.

18. A feed horn in accordance with claim 17 wherein the plastic material is metal plated.

19. A feed horn in accordance with claim 14 wherein the upper funneled portion and lower engagement portion comprise a metal material.

20. A method for providing a waveguide feed horn assembly, the method comprising:
forming a waveguide plate; and
forming at least one feed horn separate from the waveguide plate and that is configured to be removably coupled to the waveguide plate.
